(19) United States
(12) Patent Application Publication
(10) Pub. No.: US 2015/0149398 A1
(43) Pub. Date: May 28, 2015

(54) METHOD AND APPARATUS FOR DECISION MIGRATION IN A MULTI-COMPONENT ROBOT

(71) Applicant: Foundation of Soongsil University-Industry Cooperation, Seoul (KR)

(72) Inventors: JiMan Hong, Seoul (KR); Laxmisha Rai, Qingdao (CN)

(73) Assignee: Foundation of Soongsil University-Industry Cooperation, Seoul (KR)

(21) Appl. No.: 14/272,773

(22) Filed: May 8, 2014

(30) Foreign Application Priority Data
Nov. 22, 2013 (KR) 10-2013-0142808
Apr. 16, 2014 (KR) 10-2014-0045509

(51) Int. Cl. G06N 5/02

(52) U.S. Cl. CPC G06N 5/025; Y10S 901/50
USPC 706/47; 901/50

(57) ABSTRACT

A method and apparatus for decision migration within a multi-component robot are disclosed. The method of supporting decision migration between components for a multi-component robot may include: recognizing at least one subcomponent; generating at least one rule corresponding to a respective action of the at least one recognized subcomponent and embedding the at least one rule in at least one other component; and transmitting a decision or action migration request for a specific task to the other component if a failure occurs or synchronization with the other component is needed while the at least one subcomponent is performing the specific task by using the generated rule.

### CROSS-REFERENCE TO RELATED APPLICATIONS

This application claims the benefit of Korean Patent Application No. 10-2013-0142808, filed with the Korean Intellectual Property Office on Nov. 22, 2013, and Korean Patent Application No. 10-2014-0045509, filed with the Korean Intellectual Property Office on Apr. 16, 2014, the disclosures of which are incorporated herein by reference in their entirety.

### BACKGROUND

1. Technical Field

The present invention relates to a method and apparatus for knowledge-based decision migration in a multi-component robot.

2. Description of the Related Art

In the case of a multi-component robot, a centralized mode of decision-making was generally used to control the robot's actions or gestures. However, there is a growing awareness of a need to consider dynamic properties when a robot performs a particular action in real time.

For example, the actions of a mobile robot cannot be expressed with simple robot motion sequences only. That is, the motions of a mobile robot should be modified to suit the specific environment in which the mobile robot is situated.

While previous research efforts were focused on centralized decision-making, there has not been active research on dynamically modifying the motions of a robot by migrating decisions between different components within a multi-component robot.

### SUMMARY

An aspect of the invention is to provide a method and apparatus for decision migration in a multi-component robot that enable the migration of decisions or actions between different components.

Also, an aspect of the invention is to provide a method and apparatus for decision migration in a multi-component robot that allow components to share rules for knowledge-based decision-making so that a task resulting from a decision may be executed in another component.

One aspect of the invention provides an apparatus for decision migration within a multi-component robot that can migrate decisions or actions between components.

An embodiment of the invention can provide an apparatus for decision migration that interworks with a knowledge-based system and includes: a recognition part configured to recognize at least one subcomponent; a knowledge processing part configured to generate at least one rule corresponding to a respective action of the at least one recognized subcomponent and to embed the rule in at least one other component; and an action migration management part configured to transmit a decision or action migration request for a specific task to the other component if a failure occurs or synchronization with the other component is needed while the at least one subcomponent is performing the specific task by using the generated rule.

The specific task can include the at least one rule and a condition for executing the at least one rule.

The other component can load the at least one rule corresponding to the specific task in a working memory according to the decision or action migration request, with a parameter of the at least one rule modified to correspond to the other component.

The knowledge processing part can interwork with the knowledge-based system to extract a component-specific fact for each unit action of the subcomponent, and can generate the at least one rule corresponding to the action of the subcomponent by combining the extracted component-specific facts.

If there is no component-specific fact defined for the unit action of the subcomponent in the knowledge-based system, the knowledge processing part can add a component-specific fact for the unit action in the knowledge-based system by using a user function.

The other component can load at least one rule that is different from the at least one rule of the apparatus, to perform an action of the other component for performing the specific task according to the decision or action migration request or for synchronization.

The other component can include a processor, and another apparatus for decision migration can be operated by the processor, where the decision or action migration request for the specific task can be received by the other apparatus for decision migration to control the performing of a decision-making or an action of the other component.

The specific task can include a multiple number of rules that have respective priority levels, and the other apparatus for decision migration sequentially can execute the rules in the order of high priority to low priority.

A control part can further be included that is configured to execute the at least one rule corresponding to the specific task so as to perform the specific task.

The specific task can include a multiple number of rules that have respective priority levels, and the control part can sequentially execute the multiple rules in the order of high priority to low priority.

Another aspect of the invention provides a method for decision migration within a multi-component robot that can migrate decisions or actions between components.

An embodiment of the invention can provide a method of supporting decision migration between components for a multi-component robot that includes: recognizing at least one subcomponent; generating at least one rule corresponding to a respective action of the at least one recognized subcomponent and embedding the at least one rule in at least one other component; and transmitting a decision or action migration request for a specific task to the other component if a failure occurs or synchronization with the other component is needed while the at least one subcomponent is performing the specific task by using the generated rule.

The operation of generating the at least one rule can include: interworking with a knowledge-based system to extract a component-specific fact for each unit action of the subcomponent; and generating the at least one rule corresponding to the action of the subcomponent by combining the extracted component-specific facts.

The method can further include: adding a component-specific fact for the unit action in the knowledge-based system by using a user function, if there is no component-specific fact defined for the unit action of the subcomponent in the knowledge-based system.

The specific task can include multiple rules having respective priority levels, and the method can further include, after the operation of embedding the at least one rule in the other component: sequentially executing the rules in the order of high priority to low priority, where the operation of sequentially executing the rules can be performed in consideration of execution conditions for each of the multiple rules.

An embodiment of the invention can provide a method and apparatus for decision migration in a multi-component robot to enable the migration of decisions or actions between components.

Also, an embodiment of the invention can allow components to share rules for knowledge-based decision-making so that a task resulting from a decision may be executed in another component.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 schematically illustrates a framework for knowledge-based decision migration in a multi-component robot according to an embodiment of the invention.

FIG. 2 illustrates examples of component-specific facts according to an embodiment of the invention.

FIG. 3 is a block diagram schematically illustrating the internal composition of an apparatus for decision migration according to an embodiment of the invention.

FIG. 4 illustrates a rule generated for performing a greeting gesture based on component-specific facts according to an embodiment of the invention.

FIG. 5 illustrates a Hand_Close component-specific fact newly defined in a knowledge-based system by using a user function according to an embodiment of the invention.

FIG. 6 illustrates a rule corresponding to a second task according to an embodiment of the invention.

FIG. 7 illustrates program code for executing rules for performing a second task at a client according to an embodiment of the invention.

FIG. 8 illustrates program code for executing rules for performing a second task at a server synchronized with a client according to an embodiment of the invention.

FIG. 9 illustrates decision migration between components according to an embodiment of the invention.

FIG. 10 is a flowchart illustrating a method of decision migration according to an embodiment of the invention.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of the related art are omitted when it is deemed that they may unnecessarily obscure the essence of the present invention.

Certain embodiments of the present invention will be described below in detail with reference to the accompanying drawings.

The present invention relates to knowledge-based decision migration in a multi-component robot. For easier understanding, a description is first provided on a proposed framework for knowledge-based migration of decisions in a multi-component robot.

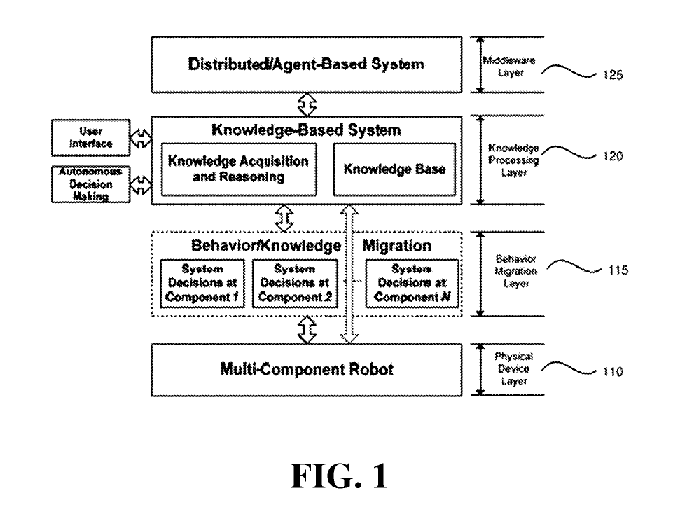

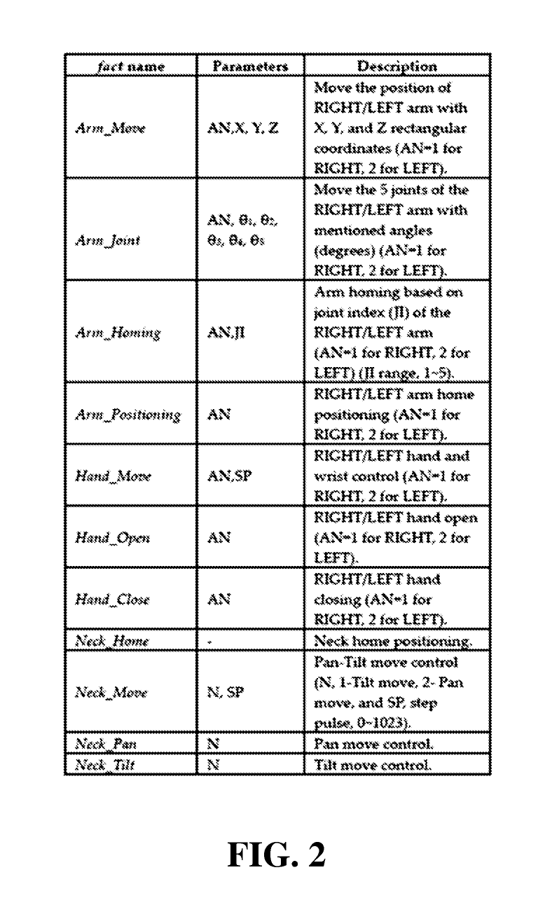

FIG. 1 schematically illustrates a framework for knowledge-based decision migration in a multi-component robot according to an embodiment of the invention, and FIG. 2 illustrates examples of component-specific facts according to an embodiment of the invention.

Referring to FIG. 1, the framework for knowledge-based decision migration in a multi-component robot according to an embodiment of the invention can include a physical device layer 110, a behavior migration layer 115, a knowledge processing layer 120, and a middleware layer 125.

The physical device layer 110 may include the actual physical robot and the multiple components that form the robot.

For example, the physical device layer 110 may include at least one sensor, actuator, communication module, processor, etc., that form the actual physical robot.

In one example, a communication module included in the physical device layer 110 may allow communication with the external environment. A communication module included in the physical device layer 110 can be included in a sensor or actuator network, in order to efficiently manage several sensors or actuators mounted on subsystem components.

In one example, the CAN protocol can be used for guaranteeing hard real-time communication between sensors and actuators included in the subsystem. In another example, a robot can include a wireless sensor network protocol such as ZigBee to facilitate communication with the external environment.

The behavior migration layer 115, which is the layer above the physical device layer 110, may allow the migrating of decisions between multiple subcomponents of the robot. The decisions at a particular component or the decisions of the entire robot system can be stored distributed over different components. A behavior migration can be required if a particular component fails to perform an expected action. For example, if the left arm of a humanoid robot fails to get a particular response, then the same action at the left arm can be migrated for the right arm to perform. The parameters for rules for such behavior migration can be mapped in such a way whereby a particular component (e.g. the right arm) may perform the action with the expected component-specific parameters. FIG. 2 shows examples of parameters for components.

For example, if the left arm of the robot is ready to pick up an object—where two arms are necessary—the left arm can migrate the decision to the right arm of the robot for cooperation.

In another example, if the left arm fails to pick up an object—where only one arm is necessary—the left arm can migrate such a decision to the right arm without the knowledge of any other components.

Decisions can be carried out at specific components of the robot in order to perform a specific task. The facts and rules may be written in such a way that decisions are attached to the specific hardware components of the robot.

The behavior migration layer 115 can also provide for the ability of synchronized coordination and failure management.

The knowledge processing layer 120, which is the layer above the behavior migration layer 115, may be responsible for knowledge acquisition, reasoning, and decision-making. The knowledge processing layer 120 may include at least one rule and fact. The number of rules can also be written in the knowledge processing layer 120.

Also, the knowledge processing layer 120 can be constituted with a knowledge-based or an expert system as a component. For example, the knowledge processing layer 120 can be constituted with a knowledge-based system as a component, such as Jess or CLIPS (C Language Integrated Production System), which allow fast execution, context focusing, interrupt handling, temporal reasoning, uncertainty handling, and truth maintenance.

The knowledge processing layer 120 can also allow the user to test the physical or behavioral constraints of any component of the robot.

Moreover, the knowledge processing layer 120 can write autonomous decision-making rules for performing specific actions based on sensor responses or environmental conditions.

The knowledge processing layer 120 can also control the whole process of applying the rules to the working memory in order to obtain the output of the system.

The knowledge processing layer 120 can also include the working memory, rule-base, pattern matcher, and inference engine.

The middleware layer 125, which forms the top layer of the framework as illustrated in FIG. 1, may provide distributed support for behavior migration and may provide the request and response within multiple components during the operation of components.

Also, the middleware layer 125 may embed multiple rules written in the knowledge-based system to enable behavior migration to other components.

The middleware layer 125 can also efficiently manage requests and responses related to communications between components. For example, complex biomimetic robots such as humanoid robots may require cooperation from multiple subcomponents, for which numerous request-related communications need to be managed effectively. These requests and responses need to be managed both within components as well as with respect to other components.

The middleware layer 125 can also manage the complexities involved in the flow of control where hierarchical, non-hierarchical, centralized, and decentralized flows are essential in managing exceptional events.

Tools such as CORBA, for example, and client-server programming can be used to realize the behavior of distributed scenarios and manage exceptional events.

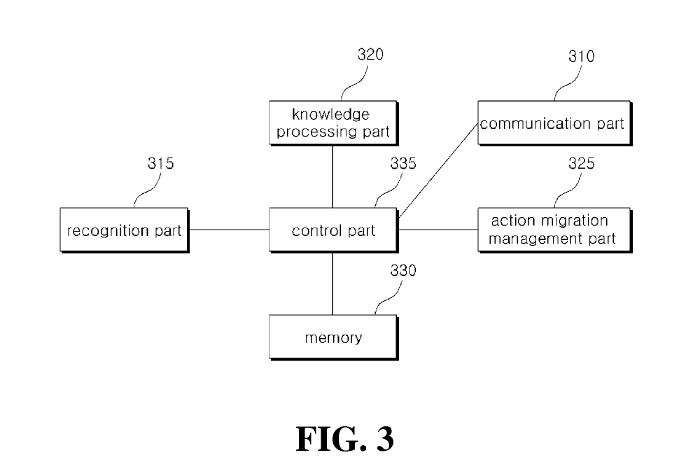

The conceptual framework supporting knowledge-based decision migration within a multi-component robot has been described above with reference to FIG. 1. Based on the conceptual framework described with reference to FIG. 1, an apparatus for decision migration such as that shown in FIG. 3 can be included in each agent to interwork with the agent and migrate decisions or actions to other components.

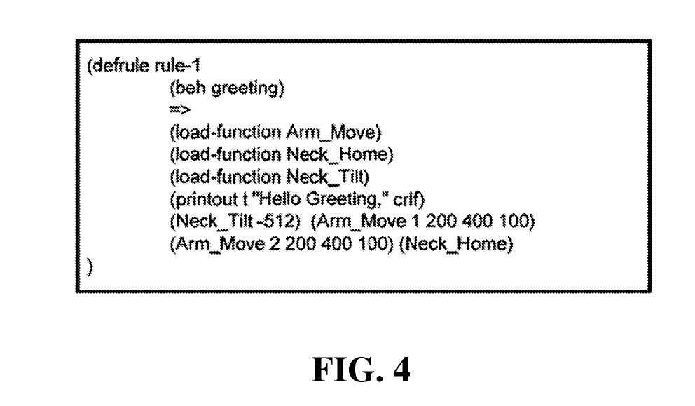

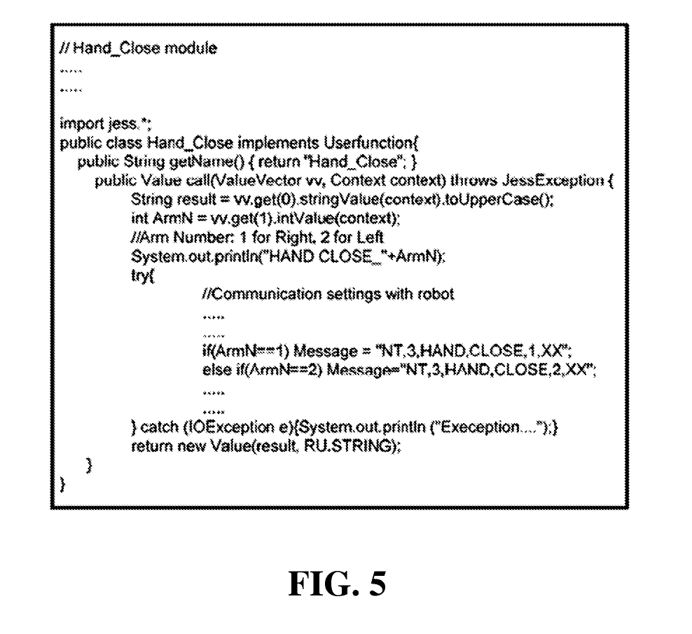

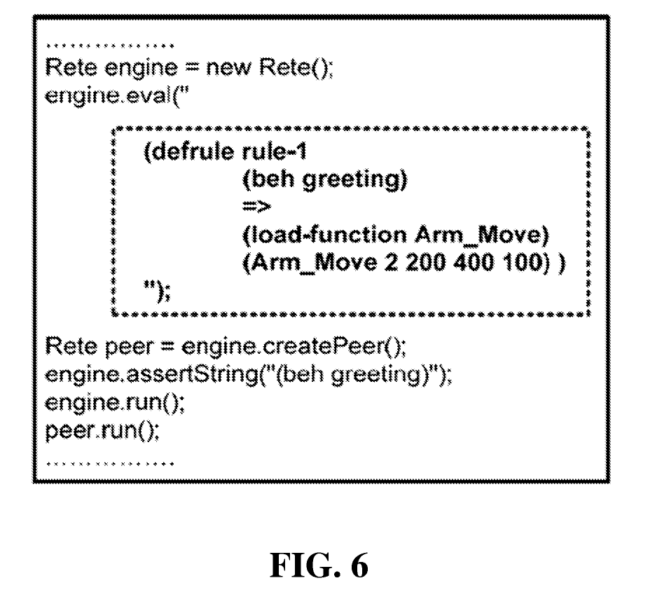

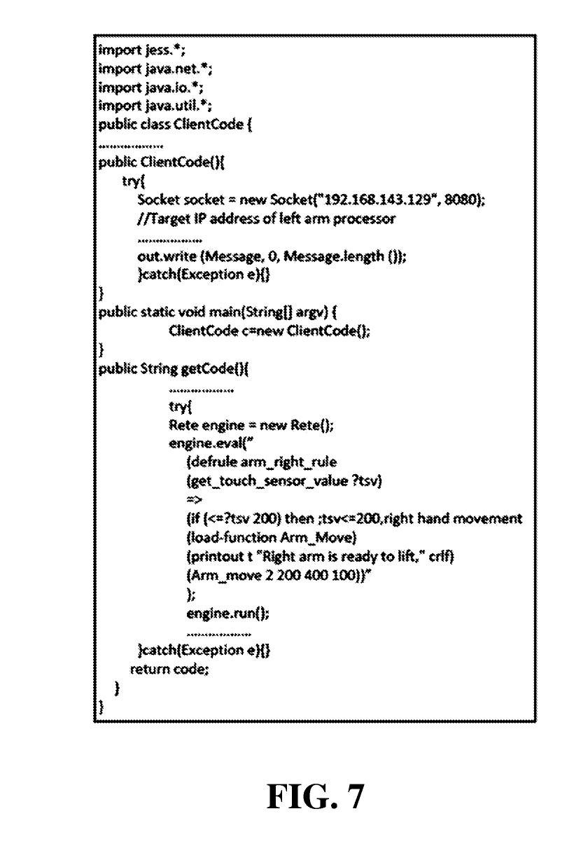

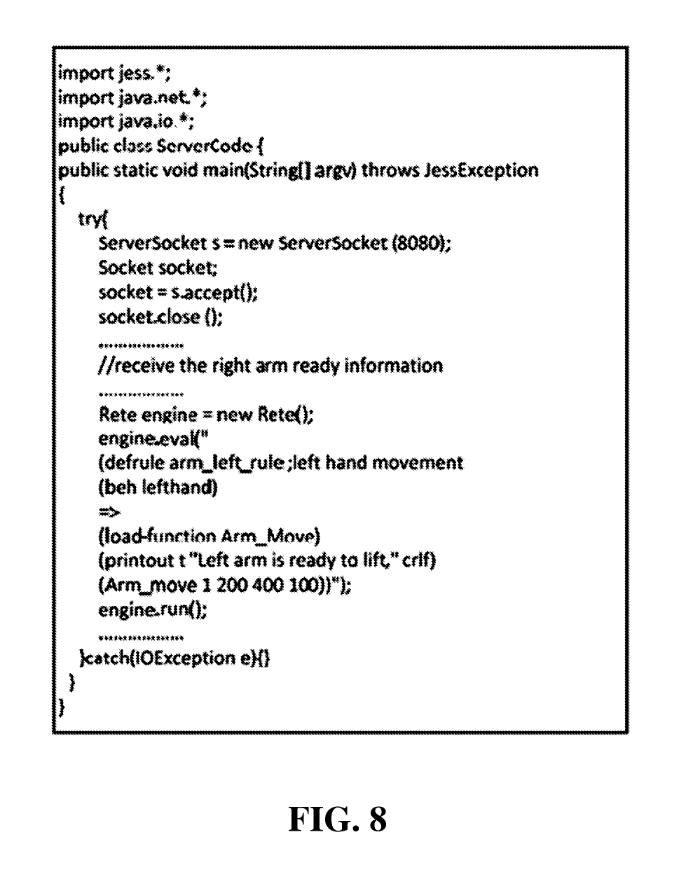

FIG. 3 is a block diagram schematically illustrating the internal composition of an apparatus for decision migration according to an embodiment of the invention, FIG. 4 illustrates a rule generated for performing a greeting gesture based on component-specific facts according to an embodiment of the invention, FIG. 5 illustrates a Hand_Close component-specific fact newly defined in a knowledge-based system by using a user function according to an embodiment of the invention, FIG. 6 illustrates a rule corresponding to a second task according to an embodiment of the invention, FIG. 7 illustrates program code for executing rules for performing a second task at a client according to an embodiment of the invention, and FIG. 8 illustrates program code for executing rules for performing a second task at a server synchronized with a client according to an embodiment of the invention.

An apparatus for decision migration may be an apparatus installed with the framework for decision migration described above with reference to FIG. 1 and can be included in each component forming a multi-component robot. That is, a component installed with a processor can operate as an agent or a server, and each agent or server can include an apparatus for decision migration. Thus, the decision migration apparatus referred to in the descriptions below should be understood as being embedded in an agent or a server of a component equipped with a processor. Also, a component installed with a processor can be implemented as one component or as multiple components divided with respect to joints.

Referring to FIG. 3, a decision migration apparatus 300 according to an embodiment of the invention may include a communication part 310, a recognition part 315, a knowledge processing part 320, an action migration management part 325, a memory 330, and a control part 335.

The communication part 310 may provide functions for exchanging data with other components or with a knowledge-based system via wired or wireless communication.

The recognition part 315 may serve to recognize the physical components of a robot that participate in performing a gesture or an action by the robot.

For example, the physical components of a robot can be physical units divided by joints, such as hands, arms, neck, head, etc., in the case of a humanoid robot. The recognition part 315 can recognize each of the physical components of the robot, for example by way of a wired or wireless communication environment. Also, the recognition part 315 can periodically check, via wired or wireless communication, whether or not each physical component is able to perform its actions. The information on the physical components of the robot recognized in this manner can be embedded in the knowledge processing part 320.

The knowledge processing part 320 may interwork with a knowledge-based system, extract component-specific facts, which may be for commands (or functions) for the actions of a component, for each of the robot's physical components from the interworked knowledge-based system, and generate at least one rule for performing a gesture or an action of the robot by using the extracted component-specific facts.

Examples of component-specific facts, which may be commands (or functions) for specific operations of each component, according to an embodiment of the invention are provided in FIG. 2.

As shown in FIG. 2, a component-specific fact may include at least one of a name, a parameter, and a description of the component-specific fact. The name of a component-specific fact may be used as the name of a unit operation for each component associated with a rule, when rules are generated for performing a specific task (i.e. a particular gesture or action).

Also, the parameters can include parameters for differentiating the component and parameters associated with various conditions of a particular action of the component, such as angle, position, range, number of repetitions, etc., when a rule is performed at a particular component.

The description may include an explanation of the component-specific fact.

The knowledge processing part 320 can extract the component-specific facts for the unit actions of each component stored in the knowledge-based system, and can then generate at least one rule for performing a specific task by loading the component-specific facts and configuring the execution condition and parameters of each component-specific fact.

FIG. 4 shows an example of a rule generated for performing a greeting gesture based on component-specific facts according to an embodiment of the invention. Referring to FIG. 4, the rule for a greeting gesture may be composed of a first component-specific fact (Arm-Move) for moving an arm, a second component-specific fact (Neck_Home) for positioning the neck at a home location, and a third component-specific fact (Neck_tilt) for tilting the neck.

It can be seen that this rule for performing the greeting gesture is configured to load the first to third component-specific facts are loaded in the memory, and afterwards configure the parameters for controlling the unit actions of the components based on the actual first to third component-specific facts, so that the component-specific facts are performed.

The knowledge processing part 320 can also embed the at least one rule generated as above in each agent or server. Thus, the rules generated by each agent can be shared with other agents or servers.

Also, if there is no component-specific fact defined for the unit action of a particular component, the knowledge processing part 320 can add component-specific facts for the unit action by using user functions.

For example, the knowledge processing part 320 can use the jess.Userfunction of the JESS knowledge-based system to define specific commands (i.e. component-specific facts) in the knowledge-based system for a particular unit action of a component.

The knowledge processing part 320 can define the name of a component-specific fact by using a predefined call command (e.g. getName( ) or Call( )) in a user function. FIG. 5 shows an example of the Hand_Close component-specific fact which may be newly defined in the knowledge-based system by using a user function.

According to an embodiment of the invention, a component-specific fact can be a command for a unit action of a component or can be a combination of multiple component-specific facts.

The action migration management part 325 may serve to request a decision or action migration for a specific task to another component if a failure occurs or synchronization with the other component is needed while at least one subcomponent is performing a specific task using the generated rules.

For example, suppose the component for the left arm and the component for the right arm of a robot are each installed with a processor, and an agent is operated by each processor. For easier understanding, the agent corresponding to the left arm will be referred to as the first agent, while the agent corresponding to the right arm will be referred to as the second agent.

While a rule is being performed by the first agent to perform a first task, if the first task fails, then the first agent can request an action migration for the first task to the second agent.

Here, the action migration request can include information on the rule for performing the first task (e.g. rule identification information).

Then, the second agent can load corresponding rules to the working memory in response to the action migration request for the first task, so that the right arm component performs the first task instead of the left arm component.

When loading the corresponding rules according to the action migration request for performing the first task, the second agent can load the rules in the working memory with the parameters modified to correspond to the right arm component, so that the first task can be performed by the right arm component.

An action migration request can include information on the rules and can further include the conditions under which the rules are to be executed.

Thus, the second agent can provide control such that the rules for performing the first task are executed if the conditions are met after the second agent loads the rules corresponding to the action migration request in the working memory.

It is to be appreciated that reference to the executing of a rule in an embodiment of the invention encompasses the interpretation that each component is operated according to the rule.

In another example, a first component and a second component may cooperate to perform a second task. For easier understanding, suppose the first component is a right arm component and the second component is a left arm component. Also, suppose that the first component and the second component are each equipped with a processor, with the processor of the first component (i.e. the right arm component) operating as a client and the processor of the second component (i.e. the left arm component) operating as a server.

Suppose that the client, i.e. the right arm component, is to perform the second task for an arm movement based on a touch sensor value (tsv) and that the second task is performed when the tsv value is smaller than or equal to 200.

When the second task is performed, the client may transmit information needed for performing the second task to the server (i.e. the left arm component). Then, the server (i.e. the left arm component) can synchronize the performing of the second task with the client (i.e. the right arm component).

In this way, decisions or actions can be migrated between client-server components.

FIG. 6 shows examples of rules corresponding to a second task according to an embodiment of the invention, FIG. 7 shows an example of program code for executing the rules for performing the second task at a client according to an embodiment of the invention, and FIG. 8 shows an example of program code for executing the rules for performing the second task at a server synchronized with a client according to an embodiment of the invention.

As illustrated in FIG. 6 to FIG. 8, the first component may request a decision or action migration for a specific task to the second component, to perform the specific task synchronized with the second component.

The memory 330 may serve to store various rules for decision migration according to an embodiment of the invention.

The control part 335 may serve to control the internal components (e.g. the communication part 310, recognition part 315, knowledge processing part 320, action migration management part 325, memory 330, etc.) of a decision migration apparatus 300 according to an embodiment of the invention.

Also, the control part 335 may also serve to execute rules corresponding to a specific task and provide control such that a particular component is operated in correspondence to the executed rules.

Here, the performing of a specific task can include multiple rules, each of which can be configured to have priority levels. In this case, the control part 335 can provide control such that the rules are performed in the order of high to low priority.

Also, if there are multiple tasks, the control part 335 can provide control such that tasks having high execution importance are performed earlier in correspondence to the specific conditions. Here, the execution importance can be configured beforehand according to the specific conditions.

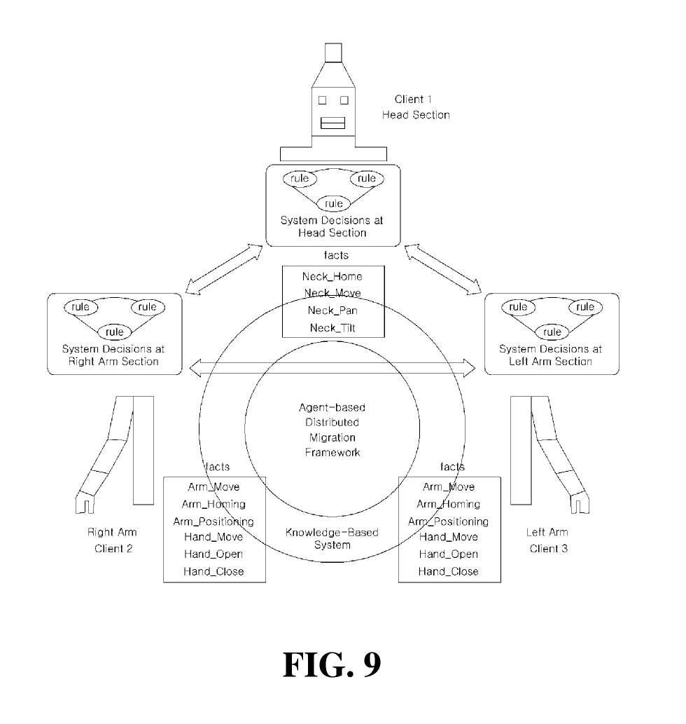

FIG. 9 illustrates decision migration between components according to an embodiment of the invention.

Suppose that a head component, a left arm component, and a right arm component, as illustrated in FIG. 9, are each equipped with a processor, with a first decision migration apparatus, a second decision migration apparatus, and a third decision migration apparatus included with the respective processors.

It is also supposed that the head component, left arm component, and right arm component are each operating as a client (or an agent) and that each client (or agent) includes a decision migration apparatus.

For easier understanding and explanation, the head component will be referred to as a first client, and it will be assumed that the first client includes a first decision migration apparatus. Also, the right arm component will be referred to as a second client, and it will be assumed that the second client includes a second decision migration apparatus. Also, the left arm component will be referred to as a third client, and it will be assumed that the third client includes a third decision migration apparatus.

The first to third decision migration apparatuses can each interwork with a knowledge-based system and can extract component-specific facts for each component.

Referring to FIG. 9, the first decision migration apparatus can extract the component-specific facts of Neck_Home, Neck_Move, Neck_pan, and Neck_Tilt.

The second decision migration apparatus and the third decision migration apparatus can each extract the component-specific facts of Arm_Move, Arm_Joint, Arm_Homing, Arm_Positioning, Hand_Move, Hand_Open, and Hand_Close.

As illustrated in FIG. 9, a single component or multiple components can be included in a decision migration apparatus.

The first to third decision migration apparatuses can each generate rules for performing a specific task (gesture or action) of the robot by using the respectively extracted component-specific facts. The rules generated in this manner by the first to third decision migration apparatuses can be embedded in other decision migration apparatuses, so that the rules generated by the decision migration apparatuses may be shared.

While in this state, if the second decision migration apparatus experiences a failure while performing a specific task for the left arm component, a decision or an action for performing the task can be migrated to the third component to be performed by the third client (agent).

That is, if a failure occurs or cooperation is needed during the performing of a specific task, each decision migration apparatus can transmit the information needed to perform the specific task to another decision migration apparatus, so that another component may perform the task.

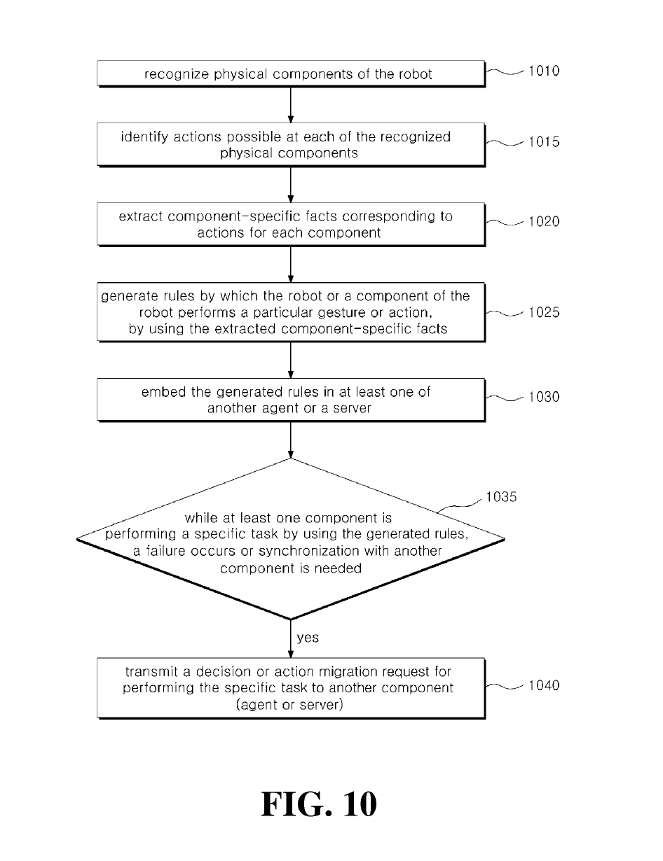

FIG. 10 is a flowchart illustrating a method of decision migration according to an embodiment of the invention.

In operation 1010, a decision migration apparatus may recognize the physical components of a robot.

For example, the decision migration apparatus can recognize at least one of the robot's physical components that participate in generating an overall gesture or action.

When all of the physical components of the robot have been recognized, the decision migration apparatus may identify the unit actions for each of the recognized components in operation 1015.

For example, the decision migration apparatus can identify the different actions that are possible in each of the recognized components. In one example, each of the recognized components can share the possible actions with other components by wired or wireless communication. The different actions for each component can be defined beforehand by the decision migration apparatus.

In operation 1020, the decision migration apparatus 300 may extract component-specific facts corresponding to the actions of each component.

As described above, the decision migration apparatus 300 can interwork with a knowledge-based system such as JESS. According to an embodiment of the invention, the interworking knowledge-based system may store various component-specific facts. Here, a component-specific fact may be a command for performing a unit action of a subcomponent and can include at least one of a name of the component-specific fact, a parameter necessary for executing the component-specific fact, and a description of the component-specific fact.

In this way, the decision migration apparatus 300 can extract component-specific facts corresponding to each of the various different actions for the respective recognized components.

For example, suppose a robot's hand is a first component. Suppose an action for moving, an action for opening the hand, and an action for closing the hand are identified for the first component. As illustrated in FIG. 2, the component-specific facts for the different actions (actions for moving, opening, and closing) recognized for the first component can be stored beforehand.

Thus, the decision migration apparatus 300 can extract Hand_Move, Hand_Open, and Hand_Close as component-specific facts for each action of the first component.

If there is no component-specific fact that corresponds to a particular action of a particular component, then the decision migration apparatus 300 can add a user-defined component-specific fact by using a user function.

In operation 1025, the decision migration apparatus 300 may generate rules by which the robot or a component of the robot may perform a particular gesture or action, by using the extracted component-specific facts.

The decision migration apparatus 300 can generate the rules according to each gesture of the robot or according to each of the particular components forming the robot. The generated rules can be generated by using at least one of the extracted component-specific facts.

In operation 1030, the decision migration apparatus 300 may embed the generated rules in at least one of another agent or a server.

As described above, a robot may include multiple components. At least one of the multiple components may operate as an agent, while at least one other component may operate as a server. Obviously, there can be multiple components that operate as agents.

That is, the rules for each gesture or action generated by the decision migration apparatus 300 can be distributed to and embedded in at least one agent and server.

In operation 1035, the decision migration apparatus 300 may determine whether or not at least one component meets with a failure or requires synchronization with another component while performing a specific task using the generated rules.

If a failure occurs or if synchronization is required, then the decision migration apparatus 300 may transmit a decision or action migration request for performing the specific task to another component (agent or server) in operation 1040.

According to the implementation method, the decision migration apparatus 300 can reattempt execution through the same component when a failure occurs during the performing of a specific task. FIG. 10 shows an example focusing on a method of migrating decisions to another component.

To be more specific, the decision migration apparatus 300 can transmit the decision or action migration request to another component, with identification information regarding rules for performing a specific task included in the decision or action migration request.

Accordingly, the other component can use the rule identification information included in the decision or action migration request to load the rules into its memory and execute the rules.

As already described above, a decision migration or action migration request can further include specific conditions for performing the specific task. In such cases, the other component can execute the rules for performing the specific task if the specific conditions are met.

A method of migrating decisions within a multi-component robot according to an embodiment of the present invention can be implemented in the form of program instructions that may be performed using various means for electronically processing information and can be recorded in a storage medium. Such a storage medium can include program instructions, data files, data structures, etc., alone or in combination.

Examples of the program of instructions may include not only machine language codes produced by a compiler but also high-level language codes that can be executed by a device, such as a computer, for example, that electronically processes information through the use of an interpreter, etc.

The hardware mentioned above can be made to operate as one or more software modules that perform the actions of the embodiments of the invention, and vice versa.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains.

What is claimed is:

1. An apparatus for decision migration interworking with a knowledge-based system, the apparatus comprising:
a recognition part configured to recognize at least one subcomponent;
a knowledge processing part configured to generate at least one rule corresponding to a respective action of the at least one recognized subcomponent and to embed the rule in at least one other component; and
an action migration management part configured to transmit a decision or action migration request for a specific task to the other component if a failure occurs or synchronization with the other component is needed while the at least one subcomponent is performing the specific task by using the generated rule.

2. The apparatus for decision migration of claim 1, wherein the specific task comprises the at least one rule and a condition for executing the at least one rule.

3. The apparatus for decision migration of claim 1, wherein the other component loads the at least one rule corresponding to the specific task in a working memory according to the decision or action migration request, with a parameter of the at least one rule modified to correspond to the other component.

4. The apparatus for decision migration of claim 1, wherein the knowledge processing part interworks with the knowledge-based system to extract a component-specific fact for each unit action of the subcomponent, and generates the at least one rule corresponding to the action of the subcomponent by combining the extracted component-specific facts.

5. The apparatus for decision migration of claim 4, wherein, if there is no component-specific fact defined for the unit action of the subcomponent in the knowledge-based system, the knowledge processing part adds a component-specific fact for the unit action in the knowledge-based system by using a user function.

6. The apparatus for decision migration of claim 1, wherein the other component loads at least one rule different from the at least one rule of the apparatus for decision migration in a working memory to perform an action of the other component for performing the specific task or synchronization according to the decision or action migration request.

7. The apparatus for decision migration of claim 1, wherein the other component comprises a processor, and another apparatus for decision migration is operated by the processor,
and wherein the decision or action migration request for the specific task is received by the other apparatus for decision migration to control a performing of a decision-making or an action of the other component.

8. The apparatus for decision migration of claim 7, wherein the specific task comprises a plurality of rules, the plurality of rules having respective priority levels,
and wherein the other apparatus for decision migration sequentially executes the plurality of rules in an order of high priority to low priority.

9. The apparatus for decision migration of claim 1, further comprising a control part configured to execute the at least one rule corresponding to the specific task so as to perform the specific task.

10. The apparatus for decision migration of claim 9, wherein the specific task comprises a plurality of rules, the plurality of rules having respective priority levels,
and wherein the control part sequentially executes the at least rules in an order of high priority to low priority.

11. A method of supporting decision migration between components for a multi-component robot, the method comprising:
recognizing at least one subcomponent;
generating at least one rule corresponding to a respective action of the at least one recognized subcomponent and embedding the at least one rule in at least one other component; and
transmitting a decision or action migration request for a specific task to the other component if a failure occurs or synchronization with the other component is needed while the at least one subcomponent is performing the specific task by using the generated rule.

12. The method of claim 11, wherein the other component loads the at least one rule corresponding to the specific task in a working memory according to the decision or action migration request, with a parameter of the at least one rule modified to correspond to the other component.

13. The method of claim 11, wherein the generating of the at least one rule comprises:
interworking with a knowledge-based system to extract a component-specific fact for each unit action of the subcomponent; and
generating the at least one rule corresponding to the action of the subcomponent by combining the extracted component-specific facts.

14. The method of claim 13, further comprising:
adding a component-specific fact for the unit action in the knowledge-based system by using a user function, if there is no component-specific fact defined for the unit action of the subcomponent in the knowledge-based system.

15. The method of claim 11, wherein the specific task comprises a plurality of rules, the plurality of rules having respective priority levels,
the method further comprises, after the embedding of the at least one rule in the other component:
sequentially executing the plurality of rules in an order of high priority to low priority,
and the sequentially executing the plurality of rules is performed in consideration of an execution condition for each of the plurality of rules.

16. A recorded medium tangibly embodying a program of instructions executable to perform a method of supporting decision migration between components for a multi-component robot, the method comprising:
recognizing at least one subcomponent;
generating at least one rule corresponding to a respective action of the at least one recognized subcomponent and embedding the at least one rule in at least one other component; and
transmitting a decision or action migration request for a specific task to the other component if a failure occurs or synchronization with the other component is needed while the at least one subcomponent is performing the specific task by using the generated rule.
